(19) United States
(12) Patent Application Publication
(10) Pub. No.: US 2016/0341166 A1
(43) Pub. Date: Nov. 24, 2016

(54) COMMON RAIL FUEL INJECTOR

(71) Applicant: CATERPILLAR INC., Peoria, IL (US)

(72) Inventors: David Eugene Martin, Dunlap, IL (US); Siddharth Nair, Peoria, IL (US); Sean Olen Cornell, Gridley, IL (US)

(73) Assignee: CATERPILLAR INC., Peoria, IL (US)

(21) Appl. No.: 14/717,408

(22) Filed: May 20, 2015

(51) Int. Cl. F02M 63/00; F02M 61/16; F02M 61/04; F02M 61/18

(52) U.S. Cl. CPC F02M 63/0077; F02M 61/18; F02M 61/168; F02M 61/04; F02M 63/0015; F02M 63/0059; F02M 63/0078

(57) ABSTRACT

A fuel injector is disclosed herein. The fuel injector includes an injection line, a control valve, a check rod, a control cavity, a high pressure inlet, and a drain line. The injection line fluidly connects a fuel inlet to an injection cavity. The control cavity is adjacent an upper end of the check rod distal to the injection cavity. The high pressure inlet fluidly connects the injection line to the control cavity. The control valve blocks the flow of fuel from the control cavity to the drain line when the control valve is in a closed position and does not block the flow of fuel from the control cavity to the drain line when the control valve is in an open position.

### TECHNICAL FIELD

The present disclosure generally pertains to a common rail fuel injector, and is directed toward controlling the flow of high-pressure fuel within the injector.

### BACKGROUND

Fuel injectors for reciprocating engines are used to control the injection of high-pressure fuel into a combustion chamber. Any leakage of the high-pressure fuel from the injector may reduce the efficiency and increase the emissions of a reciprocating engine. Improved control over when the high-pressure fuel is injected and how much of the high pressure fuel is injected may increase the efficiency and decrease the emissions of a reciprocating engine.

U.S. Pat. No. 7,278,593 to Wang et al. discloses a common rail fuel injector comprising a three-way control valve that controls the flow of high-pressure fuel to a fuel cavity for fuel injection. Specifically, when the control valve is transitioning to a first, on position, from a second, off position, high-pressure fuel is provided to both the fuel cavity and to a check control cavity, thereby preventing fuel injection until the control valve seats in the first, on position. Once seated in the first, on position, the control valve only provides high-pressure fuel to the fuel cavity allowing fuel injection to occur. To stop injection, the control valve is moved from the first, on position to the second, closed position. Once again, while the control valve is in the transition location between the two positions, high-pressure fuel is provided to both the fuel cavity and to the check control cavity thereby terminating injection. Once the control valve is seated back in the second, closed position, the fuel cavity and the check control cavity are fluidly connected.

The present disclosure is directed toward overcoming one or more of the problems discovered by the inventor.

### SUMMARY OF THE DISCLOSURE

A fuel injector is disclosed herein. In embodiments, the fuel injector includes an injector body, a control valve, a check rod, and a check biasing component. The injector body includes a control rod cavity extending therein, a fuel inlet for supplying high pressure fuel to the fuel injector, an injection end at an end of the injector body, and a tip cavity adjacent the injection end. The check rod is located within the injector body. The check rod includes a check, a rod upper end and a lower biasing interface. The check extends into the tip cavity. The check includes a check tip adjacent the injection end. The tip cavity is sized so that the check and the tip form an injection cavity there between. The rod upper end is distal to the check. The lower biasing interface is located between the check tip and the rod upper end. The lower biasing interface includes a diameter larger than that of the check and that of the rod upper end. The check biasing component is located adjacent the lower biasing interface and located between the upper body and the lower biasing interface.

The fuel injector also includes an injection line, a control cavity, a high pressure inlet, a drain line, and a control cavity outlet. The injection line fluidly connects the fuel inlet to the injection cavity. The control cavity is located between the rod upper end and a portion of the injector body. The high pressure inlet fluidly connects the injection line to the control cavity. The drain line is in flow communication with the control valve. The control cavity outlet fluidly connects the control cavity to the control valve. The control valve blocks the flow of fuel from the control cavity to the drain line when the control valve is in a closed position and does not block the flow of fuel from the control cavity to the drain line when the control valve is in an open position.

A method for remanufacturing a fuel injector is also disclosed. In embodiments, the method includes removing a housing of a control valve from an upper cavity of an upper body of the fuel injector. The method also includes boring the upper body to include a control rod cavity extending from the upper cavity through the upper body. The method further includes forming a control cavity in the fuel injector by inserting a check rod into the fuel injector and locating a rod sleeve around a rod upper end of the check rod that is distal to a check of the check rod. The method yet further includes fluidly connecting the injection line to the control cavity.

### BRIEF DESCRIPTION OF THE DRAWINGS

FIG. 1 is a schematic diagram of a fuel system.

FIG. 2 is a cross-sectional view of a fuel injector of FIG. 1.

FIG. 3 is a cross-sectional view of a portion of the fuel injector of FIG. 2.

FIG. 4 is a cross-sectional view of the fuel injector of FIG. 1 rotated at a different angle.

FIG. 5 is a cross-sectional view of an alternate embodiment of the fuel injector of FIGS. 2-4.

FIG. 6 is a cross-sectional view of a first portion of the fuel injector of FIG. 5.

FIG. 7 is a cross-sectional view of a second portion of the fuel injector of FIG. 5.

FIG. 8 is a cross-sectional view of an alternate embodiment of the fuel injectors of FIGS. 2-7.

FIG. 9 is a cross-sectional view of a portion of the fuel injector of FIG. 8.

FIG. 10 is a flowchart of a method for remanufacturing a fuel injector.

### DETAILED DESCRIPTION

The systems and methods disclosed herein include a fuel injector. In embodiments, the fuel injector includes an injection line that fluidly connects a fuel inlet to a tip cavity to supply high pressure fuel to an injection orifice. The fuel injector also includes check rod with a check located in the tip cavity and a rod upper end distal to the check and adjacent a control cavity. A check biasing component applies a force to the check rod so that the check will block the injection orifice. A high pressure inlet fluidly connects the control cavity to the injection line to supply a portion of the high pressure fuel from the injection line to the control cavity. A drain line is fluidly connected to the control cavity with a control valve that is interposed there between.

In this configuration, the control valve can be used to control the injection of high pressure fuel into a combustion chamber through the injection orifice without the majority of the high pressure fuel flowing across the control valve. When the control valve is closed, the fuel in the control cavity and the check biasing component apply a force to the check rod and hold the check in the closed position. When the control valve is open, the fuel in the control cavity flows into the drain line, which reduces the pressure of the fuel in the control cavity and allows the forces applied to the check by the fuel in the tip to overcome the check biasing component to move the check to an open position. In the open position the injection orifice is not covered allowing the high pressure fuel to pass there through. Reducing the amount of fuel passing through the control valve may reduce erosion in the valve and may improve the operating life of the control valve while maintaining precise control of the fuel injection.

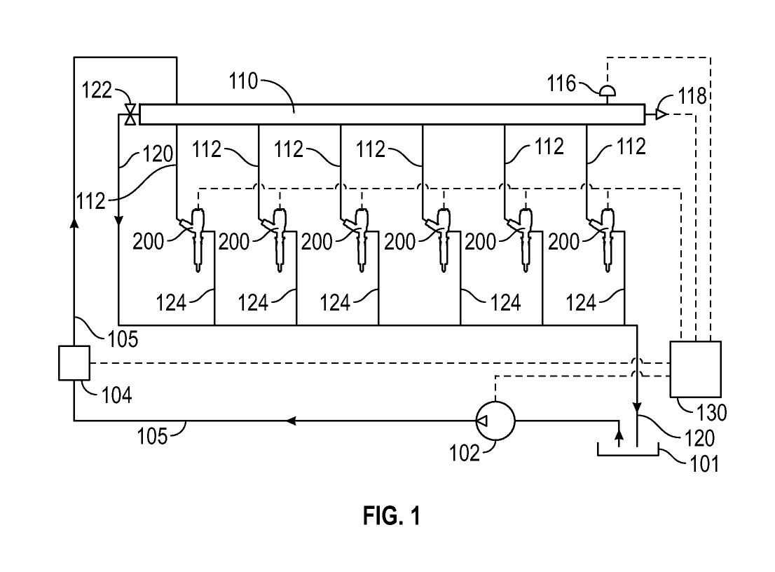

FIG. 1 is a schematic diagram of a fuel system 100. The fuel system 100 may include fuel injectors 200 connected to a fuel rail 110 in a common rail configuration. The fuel system 100 may also include a reservoir 101, a transfer pump 102, a high pressure pump 104 and a fuel line 105. Fuel line 105 is used to provide fuel to the fuel rail 110. The transfer pump 102 draws fuel from the reservoir 101 and provides the fuel to the high pressure pump 104. The high pressure pump 104 pressurizes the fuel to the desired pressure level and delivers the fuel to the fuel rail 110. A fuel supply line 112 may connect each fuel injector 200 to the fuel rail 110. The pressurized fuel is distributed through the fuel rail 110 to each fuel injector 200 through the fuel supply line 112.

The fuel system 100 may also include a reservoir return line 120, a safety valve 122, and a fuel return line 124 connected to each fuel injector 200. The reservoir return line 120 may connect to the fuel rail 110. The safety valve 122 is located on the reservoir return line 120. The pressure in the fuel rail 110 may be at least partially controlled using the safety valve 122. When the pressure within fuel rail 110 rises above the desired fuel injection pressure, safety valve 122 may allow fuel to pass into the reservoir return line 120 to reduce the pressure within the fuel rail 110. Reservoir return line 120 then directs the fuel back to the reservoir 101. Some of the fuel supplied to fuel injector 200 is used to control the injection process and is drained from the fuel injector 200. This fuel is supplied to the fuel return line 124 that directs the fuel to the reservoir return line 120. The fuel is then directed back to the reservoir 101.

The fuel system 100 may further include an electronic control module 130. The electronic control module 130 may rely on various inputs, such as the pressure and temperature of the fuel in the fuel rail 110 to provide general control for the fuel system 100. A pressure sensor 116 and a temperature sensor 118 may be used to measure the pressure and temperature of the fuel in the fuel rail 110. The electronic control module 130 may provide control signals to the transfer pump 102, the high pressure pump 104 and to each fuel injector 200 to control the injection of fuel by the fuel injectors 200 into the combustion chambers of the engine.

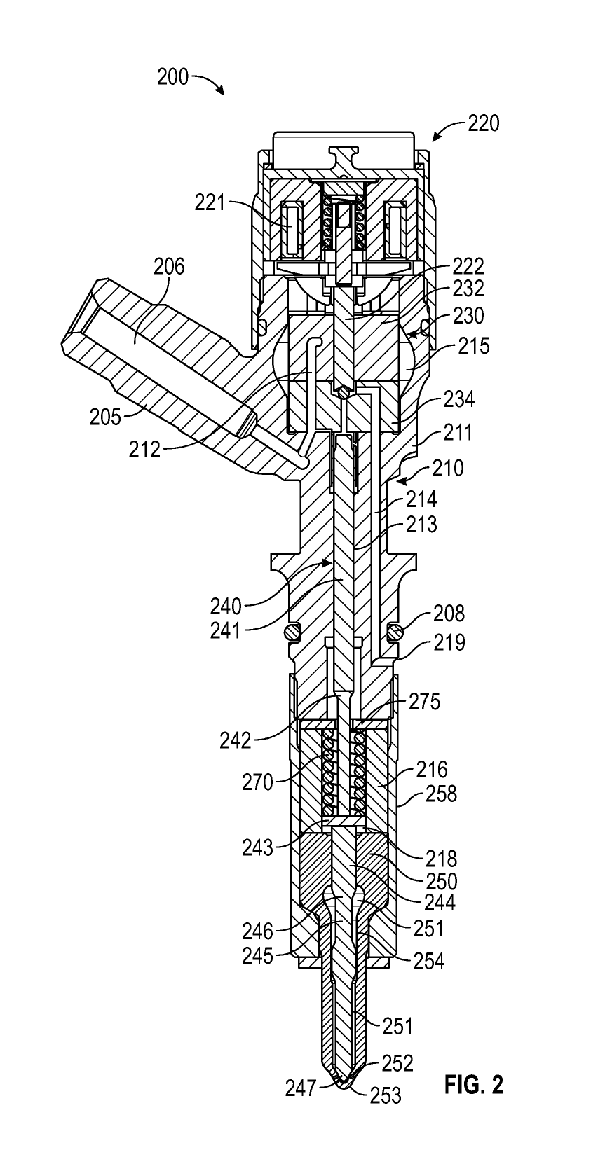

FIG. 2 is a cross-sectional view of a fuel injector 200 of FIG. 1. Referring to FIG. 2, fuel injector 200 may include an injector body 210, a control valve 220, a housing 230, a check rod 240, and a check biasing component 270, such as a spring. The injector body 210 may include an upper body 211, a fuel inlet portion 205, a nozzle sleeve 216, a tip 250, and a nozzle case 258.

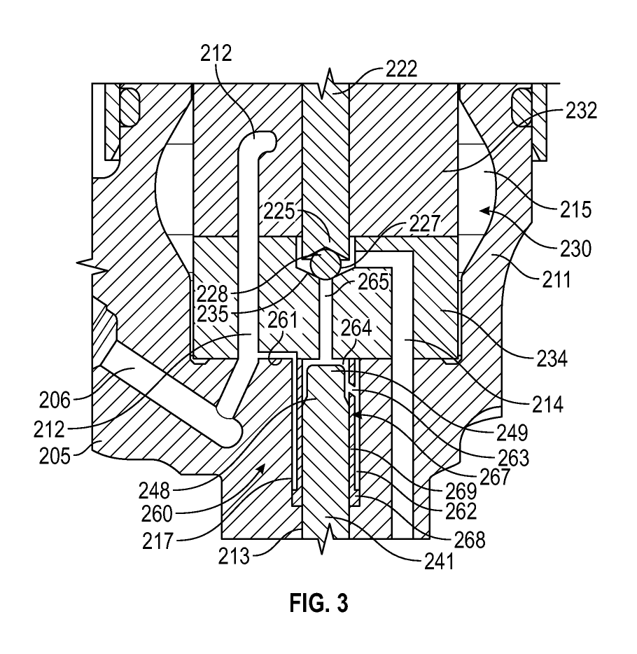

FIG. 3 is a cross-sectional view of a portion of the fuel injector 200 of FIG. 2. Referring to FIGS. 2 and 3, the upper body 211 may generally have a symmetrical shape revolved about an axis. The upper body 211 includes an upper cavity 215 and a control rod cavity 213. The upper cavity 215 may be located at an axial end of the upper body 211. Upper cavity 215 may be bored into the upper body 211. Upper cavity 215 may include a cylindrical shape with a bulbous cavity in the middle. The bulbous cavity may be a surface of revolution formed by revolving an arc of an ellipse about the axis of the upper body 211 similar to the surface of a barrel. The control rod cavity 213 may extend within injector body 210, extending through the upper body 211 from the upper cavity 215 to the opposite end of the upper body 211. In the embodiment illustrated, the control rod cavity 213 includes a sleeve bore 217. The sleeve bore 217 is a counter-bore adjacent the upper cavity 215.

The fuel inlet portion 205 may extend outward from the upper body 211 and may be located adjacent the upper cavity 215. The fuel inlet portion 205 includes a fuel inlet 206. The fuel inlet portion 205 is configured to couple with fuel supply line 112 so that fuel inlet 206 is in flow communication with the fuel supply line 112.

Nozzle sleeve 216 may be located adjacent the upper body 211 opposite the control valve 220. Nozzle sleeve 216 may have a hollow cylinder shape and includes a biasing component cavity 218 extending there through. The biasing component cavity 218 is sized to house the check biasing component 270 along with a portion of the check rod 240 therein.

The tip 250 may be located adjacent the nozzle sleeve 216 opposite the upper body 211. The tip 250 may be a solid of revolution with a needle like shape. The tip 250 includes a tip cavity 254, an injection end 253, and injection orifices 252. The tip cavity 254 may vary in diameter, with the diameter being larger than the diameter of the check rod 240 to form an annular cavity. The injection end 253 is located opposite the nozzle sleeve 216 and may have an outer diameter that is narrower than the remainder of the tip 250. The injection orifices 252 extend through the injection end 253 and are in flow communication with tip cavity 254. The injection orifices 252 are configured to be in flow communication with a combustion chamber of the engine when the fuel injector 200 is installed within the engine for injecting fuel into the combustion chamber of the engine.

The nozzle case 258 may be a hollow cylinder that overlaps with the end of upper body 211 adjacent nozzle sleeve 216, may completely cover nozzle sleeve 216, and may overlap with the end of tip 250 opposite the injection end 253. The nozzle case 258 may be configured to secure nozzle sleeve 216 and tip 250 to upper body 211.

Control valve 220 may generally be joined to the upper body 211 at the upper cavity 215. The control valve 220 may include an actuator 221, an actuator rod 222, a ball seat 227, and a ball 228. Actuator 221 is configured to displace the actuator rod 222 from a closed position to an open position. Actuator 221 may be an electrical actuator, such as a solenoid, and may be configured to displace actuator rod 222 to the open position when an electrical current is applied there to. Actuator rod 222 may include an upper seat 225 located on the end opposite the actuator 221. Upper seat 225 may be a conical seat.

Housing 230 is located in the upper cavity 215. Housing 230 may include an upper housing 232 and a lower housing 234. The upper housing 232 may include a cylindrical shape and may be located adjacent the actuator 221. The upper housing 232 includes an upper housing bore 233 that extends through upper housing 232 and is sized so that actuator rod 222 can extend there through.

The lower housing 234 is located adjacent upper housing 232 and adjacent control rod cavity 213. The lower housing 234 includes a cylindrical shape and may include the same outer diameter as the upper housing 232.

Control valve 220 also includes a lower seat 235. In the embodiment illustrated, lower seat 235 is formed in lower housing 234. The lower seat 235 may be a conical seat. The lower seat 235 and the upper seat 225 may form ball seat 227. Ball 228 is located in ball seat 227.

Check rod 240 may include a control rod 241, a connection portion 242, a lower biasing interface 243, and a check 244. Control rod 241, connection portion 242, lower biasing interface 243, and check 244 may be separate pieces located adjacent one another, may be an integral piece, or may be a combination of separate and integral pieces. The integral pieces may be formed by joining the components together, such as by bonding or by manufacturing the components as a single piece. In the embodiment illustrated, control rod 241 and connection portion 242 are an integral piece, while lower biasing interface 243 and check 244 are separate pieces.

Control rod 241 includes a rod upper end 249. Rod upper end 249 is located within sleeve bore 217 and may be adjacent lower housing 234. Rod upper end 249 may have a smaller radius than the remainder of control rod 241. Control rod 241 may also include an upper tapered portion 248 that tapers the radius of the control rod 241 to the radius of rod upper end 249.

Connection portion 242 may be adjacent to and may extend between control rod 241 and lower biasing interface 243. Connection portion 242 may pass through check biasing component 270. Connection portion 242 may be configured to transfer forces applied to control rod 241 to lower biasing interface 243 and to check 244. Lower biasing interface 243 may be positioned between check 244 and rod upper end 249. Lower biasing interface 243 may have a disk shape. Lower biasing interface 243 includes a diameter larger than the outer diameter of check biasing component 270 and may extend outward from control rod 241. Lower biasing interface 243 may be configured to transfer forces applied to lower biasing interface 243 from connection portion 242 and check biasing component 270 to check 244.

Check 244 extends from lower biasing interface 243 into tip 250. Check 244 may include a cavity portion 245, a lower tapered portion 246, and a check tip 247. Cavity portion 245 may have a smaller diameter than the remainder of check 244. Cavity portion 245 is sized to form an injection cavity 251 between tip 250 and check 244. Injection cavity 251 may be an annular cavity that is in flow communication with injection orifices 252 and is configured to supply high pressure fuel to the injection orifices 252.

Lower tapered portion 246 may taper the radius of check 244 to the radius of the lower cavity portion 245. Check tip 247 is the end of check 244 opposite lower biasing interface 243. Check tip 247 may be a conical or a rounded shape. Check 244 is configured to block injection orifices 252 off from injection cavity 251 when in a first position, a lower closed position. Check tip 247 may block injection orifices 252 and prevent the flow of the high pressure fuel out of injection cavity 251 and into a combustion chamber of the engine. Check 244 is also configured to not block injection orifices 252 when in a second position, an upper open position. Check tip 247 may not block injection orifices 252 and allow the fuel to flow from injection cavity 251 into the combustion chamber.

Check biasing component 270 is located within nozzle sleeve 216 and axially between lower biasing interface 243 and upper body 211. In some embodiments, check biasing component 270 contacts upper body 211 directly. In other embodiments, such as the embodiment illustrated, fuel injector 200 includes an upper biasing interface 275. Upper biasing interface 275 may be a disk located between upper body 211 and nozzle sleeve 216. Upper biasing interface 275 includes a bore that is sized to allow check rod 240 to extend through upper biasing interface 275, while being smaller than the diameter of check biasing component 270 so that check biasing component 270 will contact upper biasing interface 275. Check biasing component 270 is sized to be in a compressed state when installed between lower biasing interface 243 and upper biasing interface 275. Check biasing component 270 applies a force on lower biasing interface 243 toward the check tip 247 that is configured to push check tip 247 toward injection end 254.

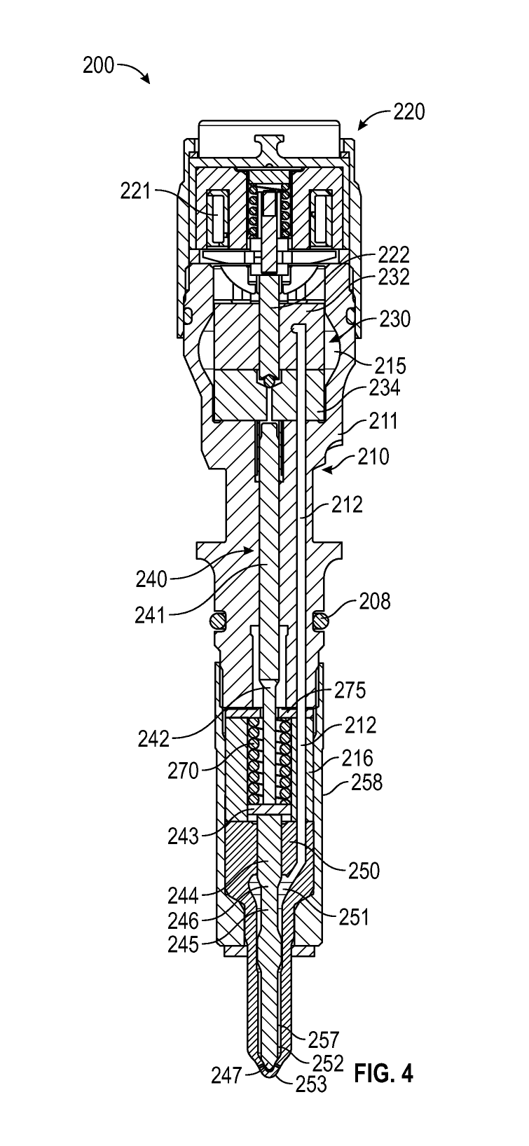

FIG. 4 is a cross-sectional view of the fuel injector 200 of FIG. 1 rotated at a different angle. Referring to FIGS. 2-4, fuel injector 200 also includes an injection line 212, a control cavity 264, a high pressure inlet 260, a control cavity outlet 265, a drain line 214, and a drain outlet 219. Injection line 212 fluidly connects fuel inlet 206 to injection cavity 251 to convey the high pressure fuel from the fuel inlet 206 to the injection cavity 251.

In the embodiment illustrated, injection line 212 extends through upper body 211 from fuel inlet 206 to housing 230. Injection line 212 extends through lower housing 234 in the axial direction to upper housing 232 and into upper housing 232. Injection line 212 may turn 90 degrees in upper housing 232 and may extend perpendicular to the axial direction across a portion of upper housing 232. Injection line 212 may then turn 90 degrees and extend down towards lower housing 234. Injection line 212 may then extend through lower housing 234, upper body 211, and nozzle sleeve 216 in the axial direction to tip 250. Injection line 212 may then extend into tip 250 to injection cavity 251. The length of injection line 212 extending through injection cavity 251 may be angled toward the axis of fuel injector 200.

Control cavity 264 is located adjacent rod upper end 249. In the embodiment illustrated, control cavity 264 is formed by a rod sleeve 267 that is inserted into sleeve bore 217 positioned around rod upper end 249 and along a portion of control rod 241. Rod sleeve 267 may be abutted to housing 230. Rod sleeve 267 may include a sleeve portion 269 and a flange portion 268. Sleeve portion 269 may be a hollow cylinder and may have an inner diameter the same or a similar size as the outer diameter of control rod 241. Flange portion 268 extends radially outward from sleeve portion 269. Flange portion 268 may extend to the cylindrical surface of sleeve bore 217 and may be configured to hold sleeve portion 269 in place within sleeve bore 217.

Control cavity 264 may have the shape of a hollow cylinder with a capped end being located axially between rod upper end 249 and housing 230 and radially between rod sleeve 267 and rod upper end 249. Rod sleeve 267 may form the outer circumference of control cavity 264. The sleeve portion 269 may extend up from rod upper end 249 and abut against housing 230 to form control cavity 264.

High pressure inlet 260 fluidly connects injection line 212 to control cavity 264, which allows a small portion of the high pressure fuel to be bled off of injection line 212 into control cavity 264. In the embodiment illustrated, high pressure inlet 260 includes an inlet bleed orifice 261, an inlet annulus 262, and a control cavity inlet 263. Inlet bleed orifice 261 may be a small orifice connecting injection line 212 to inlet annulus 262. Inlet bleed orifice 261 may be formed as a slot located at the bottom surface of lower housing 234 that extends radially from injection line 212 to the radial position of inlet annulus 262. Inlet bleed orifice 261 includes a flow area that is smaller than that of injection line 212. In embodiments, the flow area of inlet bleed orifice 261 is substantially smaller than the flow area of injection line 212.

Inlet annulus 262 is the radial gap formed between sleeve portion 269 and upper body 211 at the cylindrical surface of sleeve bore 217. Control cavity inlet 263 may be an orifice extending through sleeve portion 269. Control cavity inlet 263 fluidly connects inlet annulus 262 to control cavity 264, which allows the high pressure fuel bled off of injection line 212 to flow from inlet annulus 262 to control cavity 264.

Control cavity outlet 265 fluidly connects control cavity 264 to ball seat 227 at lower seat 235. In the embodiment illustrated, control cavity outlet 265 extends axially through lower housing 234 from control cavity 264 to lower seat 235 and is coaxial to lower housing 234. Control cavity outlet 265 is configured to be sealed off from ball seat 227 when ball 228 is in a closed position and is configured to be in flow communication with ball seat 227 when ball 228 is in an open position.

Drain line 214 is in flow communication with control cavity 264. Control valve 220 is interposed between drain line 214 and control cavity 264 to control the flow of fuel from control cavity outlet 265 to drain line 214. The control valve 220 blocks the flow of fuel from control cavity 264 to drain line 214 when control valve 220 is in a closed position and permits the flow of fuel from control cavity 264 to drain line 214 when control valve 220 is in an open position. In embodiments, drain line 214 fluidly connects ball seat 227 to drain outlet 219 for directing fuel back to the reservoir 101. In the embodiment illustrated, drain line 214 extends radially from ball seat 227 and then turns 90 degrees to extend in the axial direction to drain outlet 219. Fuel return line 124, shown in FIG. 1, connects to drain outlet 219 so that fuel can be drained from ball seat 227 and returned to reservoir 101.

Injection line 212, control cavity outlet 265, and drain line 214 may be orifices that are formed in the various components of fuel injector 200 including upper body 211, nozzle sleeve 216, tip 250, and housing 230. In some embodiments, housing 230 including upper housing 232 and lower housing 234 and the various orifices formed there in are formed using an additive manufacturing process.

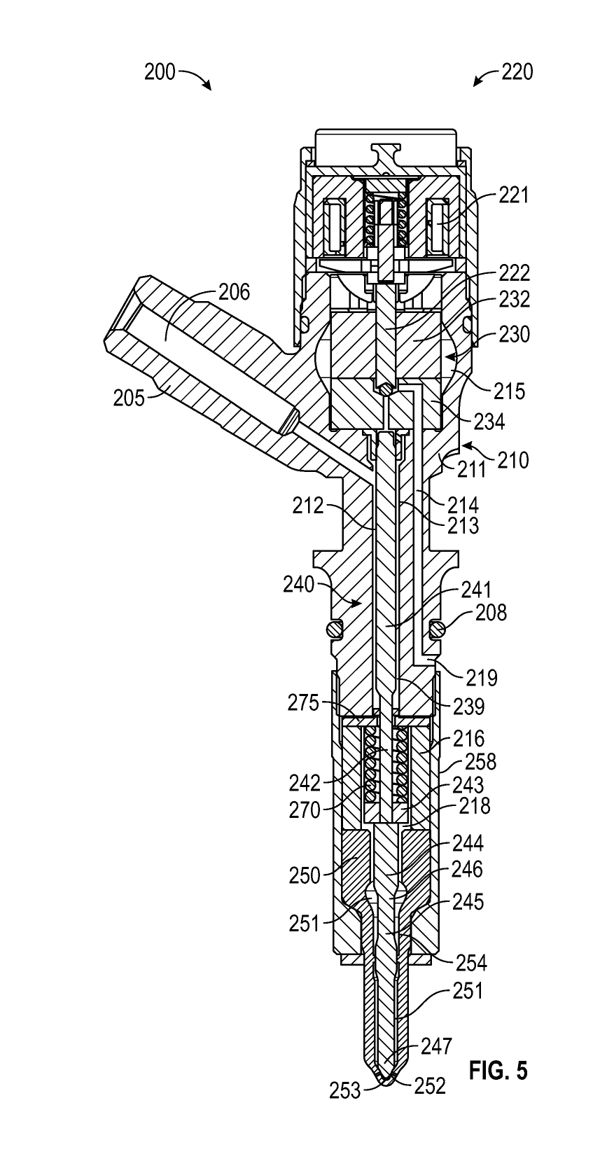

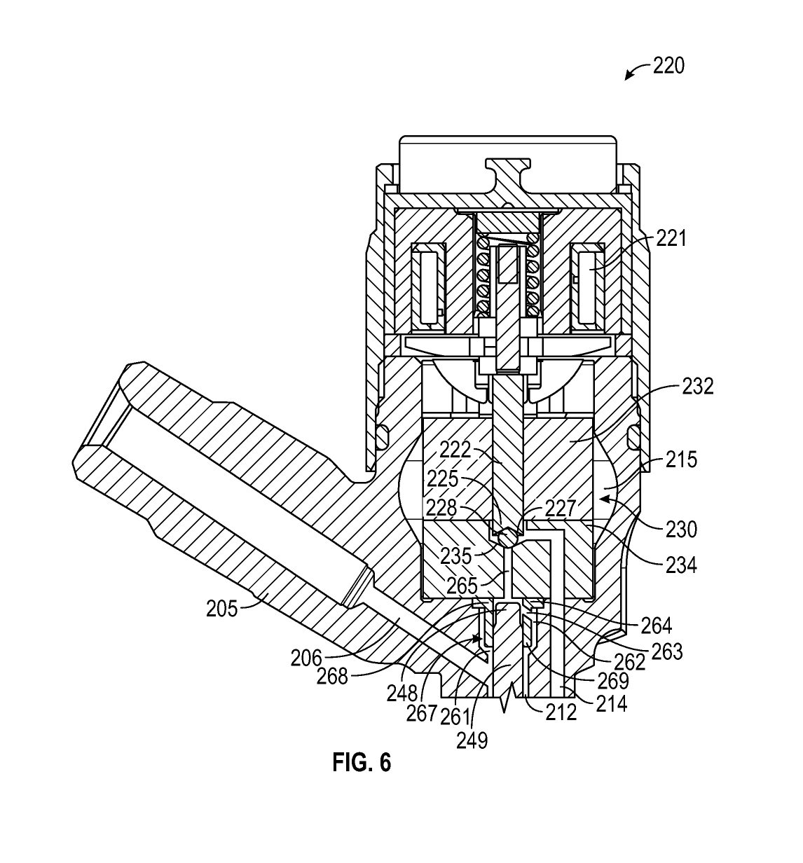

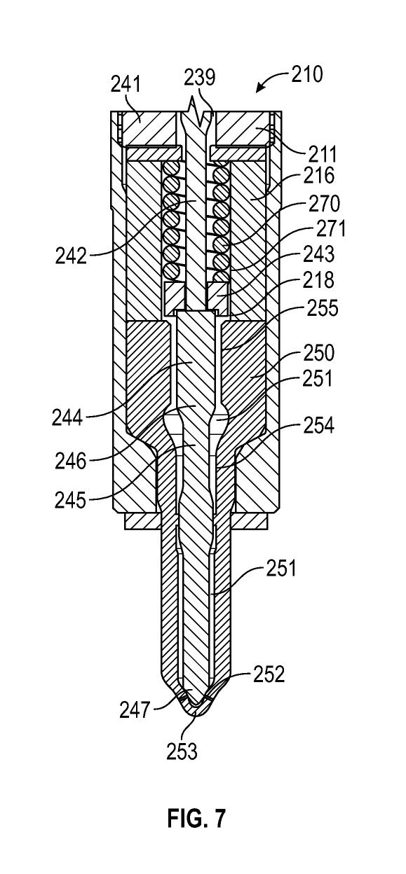

FIG. 5 is a cross-sectional view of an alternate embodiment of the fuel injector 200 of FIGS. 2-4. FIG. 6 is a cross-sectional view of a first portion of the fuel injector 200 of FIG. 5. FIG. 7 is a cross-sectional view of a second portion of the fuel injector 200 of FIG. 5. In embodiments, injection line 212 is an annular passage extending along check rod 240. In the embodiment illustrated in FIGS. 5-7, injection line 212 is an annular passage extending down injector body 210 from fuel inlet 206 to injection cavity 251 adjacent to check rod 240. The diameter of control rod cavity 213 may be sized larger than the diameter of check rod 240 to at least partially form an annular portion of injection line 212. In the embodiment illustrated, the diameter of biasing component cavity 218 is sized larger than the outer diameter of check biasing component 270 and the outer diameter of lower biasing interface 243 to form another portion of injection line 212.

Referring to FIG. 6, in this embodiment, flange portion 268 of rod sleeve 267 extends from sleeve portion 269 at a location adjacent lower housing 234. In this embodiment, inlet bleed orifice 261 extends up from injection line 212 to inlet annulus 262 along control rod 24 and may include a hollow conical frustum shape. Inlet annulus 262, control cavity inlet 263, control cavity 264, control cavity outlet 265, ball seat 227, and drain line 214 may be arranged and fluidly connected in the same or a similar manner as the embodiment described with reference to FIGS. 2-4.

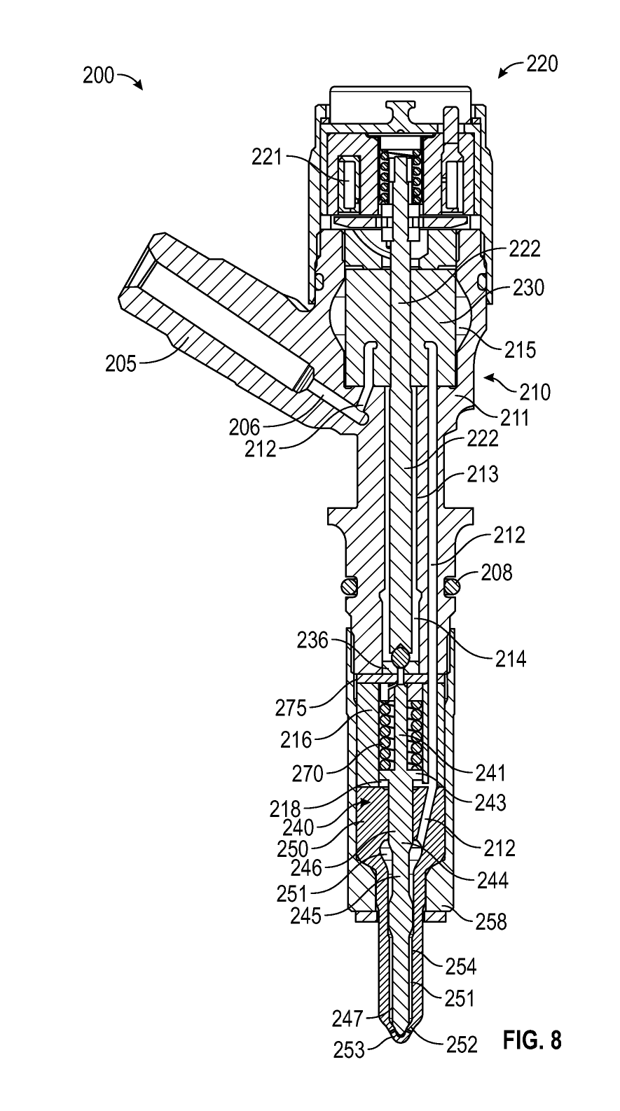

FIG. 8 is a cross-sectional view of an alternate embodiment of the fuel injectors 200 of FIGS. 2-7. In the embodiment illustrated in FIG. 8, housing 230 is single integral piece. Injection line 212 extends in the axial direction from fuel inlet 206 into housing 230. Injection line 212 then extends over and around actuator rod 222 and control rod cavity 213. Injection line 212 may then extend in the axial direction from housing 230 towards injection cavity 251. The two portions of injection line 212 extending in the axial direction within housing 230 may be located 180 degrees apart relative to the axis of housing 230.

In the embodiment illustrated in FIG. 8, the ball seat 227 is located adjacent nozzle sleeve 216 and distal to actuator 221 within upper body 211. Actuator rod 222 extends through housing 230 and into control rod cavity 213 and check rod 240 is a single integral piece. As shown in FIG. 8, fuel injector 200 may include a lower seat disk 236 located within the control rod cavity 213 at the end of upper body 211 distal to actuator 221 and adjacent nozzle sleeve 216. In the embodiment shown, lower seat disk 236 includes lower seat 235. Upper biasing interface 275 may be located between upper body 211 and nozzle sleeve 216. Lower seat disk 236 may be abutted to upper biasing interface 275.

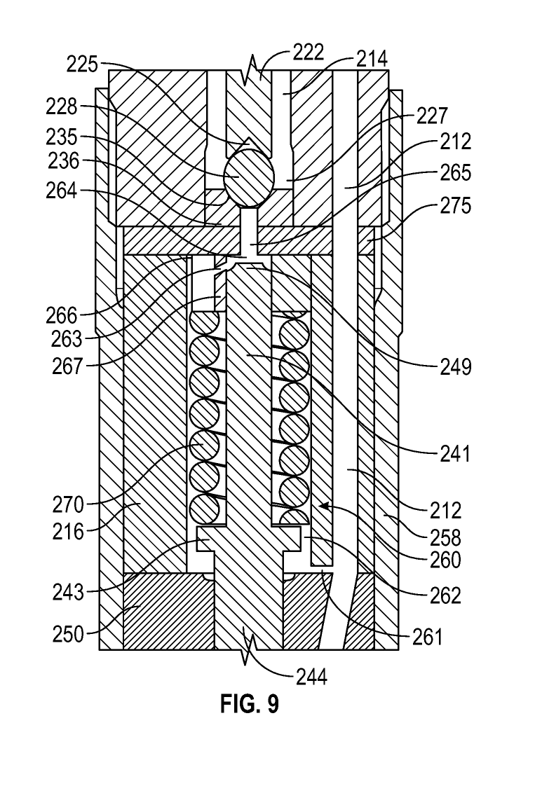

FIG. 9 is a cross-sectional view of a portion of the fuel injector 200 of FIG. 8. Referring to FIG. 9, rod upper end 249 may be adjacent upper biasing interface 275 forming control cavity 264 there between. In the embodiment illustrated, rod sleeve 267 is located between upper biasing interface 275 and check biasing component 270 and acts as an upper interface for check biasing component 270. Rod sleeve 267 may be abutted to upper biasing interface 275. Rod sleeve 267 forms the outer circumference of control cavity 264. Rod sleeve 267 may have a horizontal cylinder shape with an outer portion removed. High pressure inlet 260 may also include a connection orifice 266. Connection orifice 266 may be formed between rod sleeve 267 and nozzle sleeve 216 where the outer portion would be. Connection orifice 266 may be a slot or may be the shape of a horizontal cylindrical segment.

Inlet annulus 262 may be an annular cavity formed in biasing component cavity 218. Biasing component cavity 218 may have a diameter larger than the outer diameter of check biasing component 270 and larger than the outer diameter of lower biasing interface 243 which forms the annular cavity. Inlet bleed orifice 261 extends through nozzle sleeve 216 to connect injection line 212 to inlet annulus 262. In the embodiment illustrated, inlet bleed orifice 261 extends in the radial direction. Inlet annulus 262 may be axially adjacent connection orifice 266 and may be in flow communication with connection orifice 266.

In the embodiment illustrated, control cavity inlet 263 extends from connection orifice 266 to control cavity 264 so that control cavity 264 is in flow communication with connection orifice 266. Control cavity outlet 265 extends from control cavity 264 to ball seat 227 through upper biasing interface 275 and lower seat disk 236.

Referring to FIGS. 8 and 9, drain line 214 is an annular passage extending up from ball seat 227 and is located between upper body 211 and actuator rod 222. In the embodiment illustrated, drain line 214 extends up to housing 230. Drain line 214 is in flow communication with a drain outlet similar to drain outlet 219 shown in FIG. 5. The drain outlet may extend radially from an outer surface of upper body 211 to drain line 214.

### INDUSTRIAL APPLICABILITY

Precise control of fuel delivery by the fuel injectors may improve the efficiency and reliability of the engine. High pressure fuel passing through a control valve may contain contaminants which may cause erosion within the valve. Erosion within the valve may result in leakage of fuel through the valve, which may affect the delivery of fuel by the fuel injectors.

In fuel injectors 200, high pressure fuel is directed through injection line 212 from fuel inlet 206 to injection cavity 251 without passing through ball seat 227. A portion of the high pressure fuel that enters into the fuel injector 200 at fuel inlet 206 is bled off of injection line 212 through high pressure inlet 260 and directed into control cavity 264. When the control valve 220 is in a closed position, ball 228 is positioned to block control cavity outlet 265, which holds the high pressure fuel in place in the control cavity 264. When high pressure fuel is located in control cavity 264, the high pressure fuel exerts a force on check rod 240 in a first direction. The high pressure fuel located in injection cavity 251 exerts a force on check rod 240 in a second direction, opposite the first direction. In the embodiment illustrated, the first direction is in the axial direction of the axis of fuel injector 200 traveling from upper body 211 to tip 250.

Check biasing component 270 is configured to apply a force in the first direction to check rod 240. The combined forces applied in the first direction by check biasing component 270 and the high pressure fuel in control cavity 264 are greater than the force applied in the second direction by the high pressure fuel in injection cavity 251 when control valve 220 is closed. The resulting force in the first direction biases check 244 in the first direction and holds check 244 in a closed position where check tip 247 is positioned to block injection orifices 252.

When control valve 220 is actuated, control valve 220 no longer blocks the flow of fuel and allows the fuel located in control cavity 264 to pass through control cavity outlet 265 and into drain line 214. In the embodiments illustrated, actuator 221 is energized, moving actuator rod 222 away from lower seat 235 so that ball 228 will no longer block the flow and permits fuel to flow into ball seat 227 from control cavity 264. This allows the fuel to flow through ball seat 227 into drain line 214 and to return back to reservoir 101.

The moment control valve 220 begins to open, the pressure in control cavity 264 is reduced, lowering the combined force applied in the first direction by the fuel in control cavity 264 and the check biasing component 270 below the force applied in the second direction by the high pressure fuel in injection cavity 251. The force of applied by the high pressure fuel in injection cavity 251 displaces check 244 in the second direction to an open position. The open position may be where the force applied by the high pressure fuel in injection cavity 251 is in equilibrium with the force of check biasing component 270 that increases as check biasing component 270 compresses due to the movement of check rod 240. When check 244 moves from the closed position, check tip 247 no longer blocks injection orifices 252 allowing the high pressure fuel to pass through injection orifices 252 and into the combustion chamber.

The lower pressure condition in control cavity 264 will remain until control valve 220 is fully closed, such as returning actuator rod 222 and ball 228 to their closed positions. Once ball 228 is in the closed position, control cavity 264 returns to the high pressure condition that increases the force applied to check rod 240 in the first direction so that check 244 returns to the closed position.

The injection of fuel by fuel injectors 200 may be precisely controlled since injection occurs from the moment control valve 220 begins to open and continues until control valve 220 is closed. The transition of control valve 220 between the open and closed positions may not affect the injection of the fuel since the injection is controlled by the pressure in control cavity 264, rather than directly by control valve 220.

The fuel injected into the combustion chamber is routed around control valve 220, such as around ball seat 227, rather than through control valve 220. Only the fuel bled off of injection line 212 into control cavity 264 may be directed through control valve 220, such as through ball seat 227, which may reduce erosion of components within control valve 220. Reducing erosion within control valve 220 may improve the operating life of the fuel injector 200 and may prevent excessive leakage from fuel injector 200.

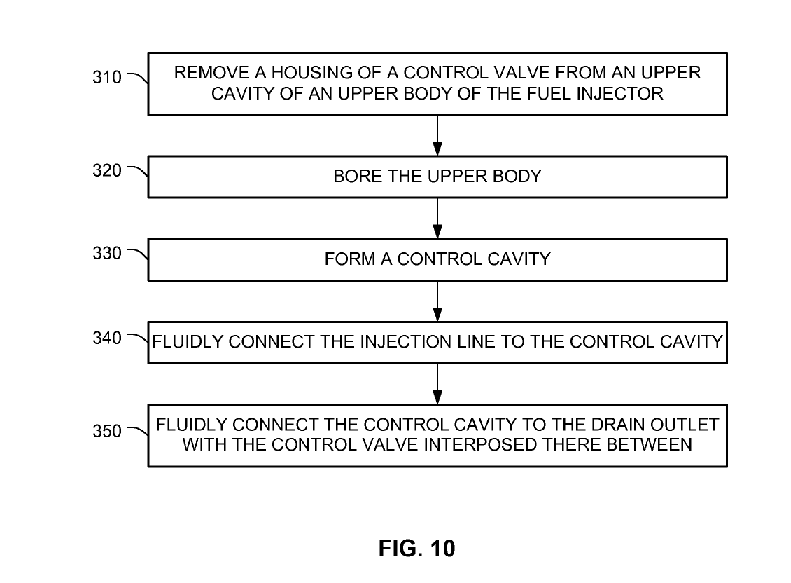

Once removed from an engine, fuel injectors may be remanufactured to further extend their operating life. Remanufacturing the fuel injectors may include reconfiguring the fuel injector to include the components and features of fuel injectors 200. FIG. 10 is a flowchart of a method for remanufacturing a fuel injector. The method includes removing a housing of a control valve from an upper cavity of an upper body of the fuel injector at step 310. The housing may have any configuration. In some embodiments, the housing may have the same or a similar configuration as housing 230.

The method also includes boring the upper body at step 320. Boring the upper body includes boring a control rod cavity 213 through the upper body, the control rod cavity 213 extending from the upper cavity to the end of the upper body opposite the upper cavity. Boring the upper body may also include boring a sleeve bore 217 into the upper body adjacent the upper cavity. Boring the upper body may further include re-boring the upper cavity in preparation to receive a new housing 230.

The method further includes forming a control cavity 264 at step 330. Forming the control cavity 264 may include inserting a check rod 240 into the fuel injector and locating a rod sleeve 267 around a rod upper end 249 of check rod 240. In some embodiments, forming control cavity 264 includes inserting housing 230 into the upper cavity and locating the rod upper end 249 adjacent housing 230. In other embodiments, forming control cavity 264 includes inserting a lower seat disk 236 into control rod cavity 213 at the end of the upper body opposite the upper cavity and locating rod upper end 249 adjacent lower seat disk 236. In some embodiments, an upper biasing interface 275 may be located between lower seat disk 236 and rod sleeve 267.

Housing 230 may be formed of one or more pieces, such as upper housing 232 and lower housing 234. The method may include forming housing 230 to include a portion of injection line 212 with a path around a ball seat 227 and does not pass through the ball seat 227. Housing 230 may be formed using additive manufacturing, which may allow for the formation of the portion of the injection line 212 therein with multiple 90 degree turns.

The method yet further includes fluidly connecting injection line 212 to control cavity 264 at step 340. Fluidly connecting injection line 212 to control cavity 264 may include forming a high pressure inlet 260 in the fuel injector. Forming high pressure inlet 260 may include forming an inlet bleed orifice 261, forming an inlet annulus 262, and forming a control cavity inlet 263. Inlet bleed orifice 261 may be formed in housing 230 or in a nozzle sleeve 216. Inlet annulus 262 may be formed between rod sleeve 267 and upper body 211 or may be formed between check rod 240 and nozzle sleeve 216. Control cavity inlet 263 may be an orifice extending through rod sleeve 267.

The method further include fluidly connecting control cavity 264 to drain outlet 219 with the control valve 220 interposed there between at step 350. Fluidly connecting control cavity 264 to drain outlet 219 may include fluidly connecting control cavity 264 to ball seat 227. In some embodiments, control cavity 264 is fluidly connected to ball seat 227 by forming a control cavity outlet 265 in housing 230. In other embodiments control cavity 264 is fluidly connected to ball seat by forming a control cavity outlet 265 in lower seat disk 236.

Fluidly connecting control cavity 264 to drain outlet 219 may also include fluidly connecting ball seat 227 to a drain outlet 219. Fluidly connecting ball seat 227 to a drain outlet 219 may include forming at least a portion of a drain line 214 in housing 230. In some embodiments, actuator rod 222 may be replaced to form an upper seat 225 of ball seat 227 and a ball 228 may be inserted into ball seat 227. Other modifications may be made to the fuel injector to form the various features of fuel injector 200 disclosed herein.

The process illustrated in FIG. 10 is subject to many variations, including adding, omitting, reordering, or altering steps. Additionally, steps may be performed concurrently. For example, step 340 may be performed before, after, or concurrently with step 350.

The preceding detailed description is merely exemplary in nature and is not intended to limit the invention or the application and uses of the invention. The described embodiments are not limited to use in conjunction with a particular type of machine. Hence, although the present disclosure, for convenience of explanation, depicts and describes particular implement system, it will be appreciated that the thumb frame assembly in accordance with this disclosure can be implemented in various other configurations and can be used in other types of implement systems. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A fuel injector comprising:
an injector body including
a control rod cavity extending therein,
a fuel inlet for supplying high pressure fuel to the fuel injector,
an injection end at an end of the injector body,
a tip cavity adjacent the injection end, and
an injection orifice extending through the injection end and in flow communication with the tip cavity for injecting the high pressure fuel into a combustion chamber of an engine;
a check rod located within the injector body, the check rod including
a check extending into the tip cavity, the check including a check tip adjacent the injection end and configured to block the injection orifice when the check is in a first position and configured not to block the injection orifice when the check is in a second position, wherein the tip cavity is sized so that the check and the tip form an injection cavity there between,
a rod upper end distal to the check, and
a lower biasing interface located between the check tip and the rod upper end, the lower biasing interface including a diameter larger than that of the check and that of the rod upper end;
a check biasing component located adjacent the lower biasing interface;
an injection line extending from the fuel inlet to the injection cavity and fluidly connecting the fuel inlet to the injection cavity;
a control cavity located between the rod upper end and a portion of the injector body;
a high pressure inlet fluidly connecting the injection line to the control cavity;
a drain line for directing fuel back to a reservoir;
a control cavity outlet fluidly connecting the control cavity to the drain line; and
a control valve interposed between the control cavity outlet and the drain line, wherein the control valve blocks a flow of fuel from the control cavity to the drain line when the control valve is in a closed position and permits the flow of fuel from the control cavity to the drain line when the control valve is in an open position.

2. The fuel injector of claim 1, wherein the injector body includes a housing adjacent the control cavity, the housing including a lower seat of the control valve, and wherein the control cavity outlet extends through the housing from the lower seat to the control cavity.

3. The fuel injector of claim 1, further comprising a rod sleeve positioned over the rod upper end and abutted to the housing to form the control cavity.

4. The fuel injector of claim 2, wherein the rod sleeve includes a sleeve portion with a hollow cylinder shape that is positioned around the rod upper end and a flange portion extending between the sleeve portion and the injector body, and wherein the high pressure inlet includes an inlet annulus formed between the sleeve portion and the injector body, an inlet bleed orifice extending from the injection line to the inlet annulus, and a control cavity inlet extending through the sleeve portion from the inlet annulus to the control cavity.

5. The fuel injector of claim 1, wherein the injection line extends through the housing.

6. The fuel injector of claim 1, wherein the injection line is an annular passage extending along check rod formed at least partially by a diameter of the control rod cavity being sized larger than that of the check rod.

7. The fuel injector of claim 1, wherein the injector body includes a lower seat disk located in an end of the control rod cavity, the lower seat disk including a lower seat of the control valve.

8. The fuel injector of claim 6, further comprising a rod sleeve positioned over the rod upper end and abutted to the check biasing component, the rod sleeve being located between the check biasing component and the lower seat disk.

9. A fuel injector comprising:
an injector body including
an upper body including a control rod cavity extending at least partially there through,
a fuel inlet portion adjacent the upper body, the fuel inlet portion including a fuel inlet extending there through;
a nozzle sleeve adjacent the upper body, the nozzle sleeve including a biasing component cavity extending there through, and
a tip adjacent the nozzle sleeve, the tip including
an injection end distal to the nozzle sleeve,
a tip cavity extending from the injection end toward the nozzle sleeve, and
an injection orifice extending from the tip cavity through the injection end;
a check rod located within the injector body, the check rod including
a check extending into the tip cavity, the check including a check tip adjacent the injection end, wherein the tip cavity is sized so that the check and the tip form an injection cavity there between,
a control rod including a rod upper end distal to the check, and
a lower biasing interface extending outward from the control rod;
a check biasing component located adjacent the lower biasing interface and located between the upper body and the lower biasing interface;
an injection line fluidly connecting the fuel inlet to the injection cavity;
a control cavity located between the rod upper end and a portion of the injector body;
a high pressure inlet fluidly connecting the injection line to the control cavity;
a control valve including
an actuator rod extending into the upper body,
an actuator for moving the actuator rod from a closed position to an open position,
a ball seat adjacent the actuator rod, and
a ball located within the ball seat;
a control cavity outlet fluidly connecting the control cavity to the ball seat, wherein the ball is configured to block the flow of fuel from the control cavity to the ball seat when the actuator is in the closed position and permit the flow of fuel from the control cavity to the ball seat when the actuator is in the open position; and
a drain line in flow communication with the ball seat to allow fuel entering the ball seat to drain from the fuel injector.

10. The fuel injector claim 8, wherein the upper body includes an upper cavity adjacent the control rod cavity, wherein the injector body further includes a housing located in the upper cavity, the housing including a lower seat of the ball seat, and wherein the control cavity outlet extends through the housing from the lower seat to the ball seat.

11. The fuel injector claim 9, further comprising a rod sleeve positioned over the rod upper end and abutted to the housing to form the control cavity.

12. The fuel injector claim 10, wherein the rod sleeve includes a sleeve portion with a hollow cylinder shape that is positioned around the rod upper end and a flange portion extending between the sleeve portion and the upper body, and wherein the high pressure inlet includes an inlet annulus formed between the sleeve portion and the injector body, an inlet bleed orifice extending from the injection line to the inlet annulus, and a control cavity inlet extending through the sleeve portion from the inlet annulus to the control cavity.

13. The fuel injector claim 9, wherein the injection line extends through the housing.

14. The fuel injector claim 9, wherein the injection line is an annular passage extending along check rod formed at least partially by a diameter of the control rod cavity being sized larger than that of the check rod.

15. The fuel injector claim 8, wherein the injector body includes a lower seat disk located in the control rod cavity and adjacent the nozzle sleeve, the lower seat disk including a lower seat of the ball seat.

16. The fuel injector claim 14, further comprising a rod sleeve positioned over the rod upper end and abutted to the check biasing component, the rod sleeve being located between the check biasing component and the lower seat disk.

17. A method for remanufacturing a fuel injector, the method comprising:
removing a housing from an upper cavity of an upper body of the fuel injector;
boring the upper body to include a control rod cavity extending from the upper cavity through the upper body;
forming a control cavity in the fuel injector by inserting a check rod into the fuel injector and locating a rod sleeve around a rod upper end of the check rod that is distal to a check of the check rod;
fluidly connecting an injection line to the control cavity; and
fluidly connecting the control cavity to a drain outlet with a control valve interposed there between.

18. The method of claim 16, wherein fluidly connecting the control cavity to the drain outlet includes forming a new housing that includes a lower seat for a ball seat of the control valve and a control cavity outlet that fluidly connects the control valve to the ball seat.

19. The method of claim 17, further comprising forming the new housing to include a portion of the injection line with a path around the ball seat that does not pass through the ball seat.

20. The method of claim 16, wherein boring the upper body also includes re-boring the upper cavity.
